(19) United States
(12) Patent Application Publication
(10) Pub. No.: US 2004/0169770 A1
(43) Pub. Date: Sep. 2, 2004

(54) All sky imager

(76) Inventors: Kevin B. Widener, West Richland, WA (US); Charles N. Long, Kennewick, WA (US)

Correspondence Address: BATTELLE MEMORIAL INSTITUTE, ATTN: STEPHEN R. MAY MSIN K1-53, P. O. BOX 999, RICHLAND, WA, 99352, US

(21) Appl. No.: 10/377,042

(22) Filed: Feb. 28, 2003

(51) Int. Cl. H04N 5/225

(52) U.S. Cl. 348/373; 348/207.1

(57) ABSTRACT

Disclosed is an All Sky Imager which uses a camera capable of capturing color images of cloud cover that is housed in an environmentally protected enclosure to protect it from weather elements. To obtain a good hemispherical view of the sky, the fish-eye lens is attached to the camera to provide a 360-degree, horizon-to-horizon view. The All Sky Imager is mounted on a solar tracker so that the image of the sun is blocked by one of the solar tracker's obscuration balls. This in effect places a shadow over the lens of the camera allowing the color capture of sky images, particularly cloud cover, without the danger of damaging the camera. As the earth rotates, the obscuration ball of the solar tracker keeps the camera obscured from the sun. This provides continuous images of sky cloud cover from sunrise to sunset. The invention also includes an embodiment using an infrared camera that allows for nighttime cloud imaging.

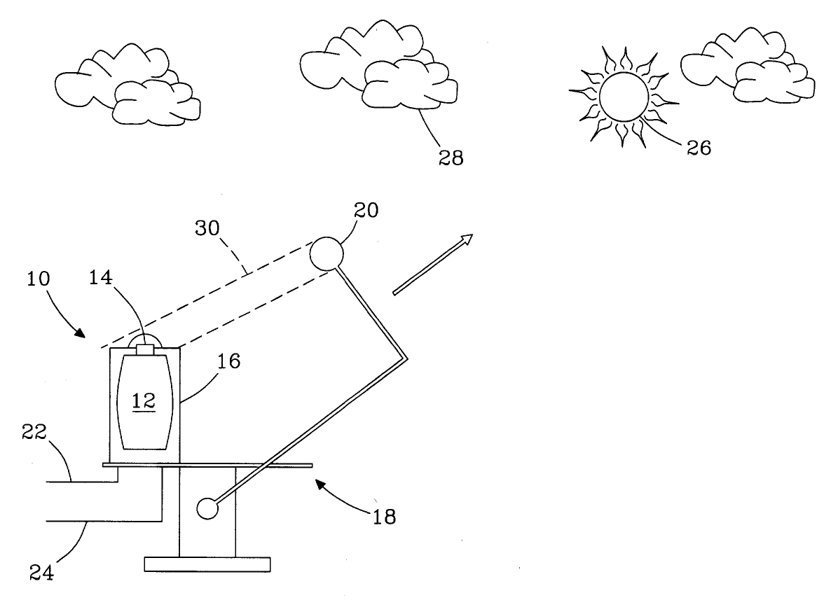

The invention was made with Government support under Contract DE-AC0676RLO 1830, awarded by the U.S. Department of Energy. The Government has certain rights in the invention.

### TECHNICAL FIELD

This invention relates to an improved apparatus for providing accurate and timely images of sky cloud cover by utilizing an off-the-shelf solar tracker and fitting it with an off-the-shelf camera to capture images of cloud cover. Cloud imaging has become an increasingly common tool for capturing sky images which is subsequently used in analyzing the percent of the sky that is covered by the clouds.

### BACKGROUND OF THE INVENTION

There have been a number of examples of instruments and methods for estimating the percent of cloud cover, including the Whole Sky Imager (WSI), manufactured by Scripps Institute and Total Sky Imager (TSI), manufactured by Yankee Environmental Systems. Both the WSI and TSI use an occultor band that obscures a significant portion of the sky in order to block the camera from viewing the sun. The TSI invention also obscures the zenith due to the location of the camera over a hemispherical mirror. The WSI obscures the zenith near solar noon whether the sun is at zenith or not. This is important since most cloud observing instruments, specifically radars and lidars, look at this portion of the sky. The current TSI invention is designed to use a single type of camera, thus preventing a user from utilizing different cameras depending on the light visibility and other environmental conditions.

The major challenge in imaging the whole sky and determining the cloud fraction is capturing a cloud image without the sun damaging the imaging system, i.e. camera, or saturating the detector array with light and thus rendering a large portion of the image unusable. A method must be used to block the image of the sun from the camera. The systems that are on the market today use occulting bands or extensive carriage systems that block significant portions of the sky adding to the uncertainty when determining cloud fraction. The present invention eliminates these problems through the use of proven solar tracker technology that also increases the reliability of the overall system. By utilizing obscuration balls (spherical objects on rods that the solar tracker keeps between the sun and the camera thus shadowing the camera from the sun) only a small portion of the sky is blocked.

### SUMMARY OF THE INVENTION

One object of this invention is to mount an off-the-shelf color camera with an auto-iris lens within an environmentally protected enclosure and to place this protected enclosure in communication with an off-the-shelf solar tracker to capture sky images. A shading/obscuration ball on the solar tracker prevents direct sunlight from hitting the camera without which the camera detector array may be saturated or damaged. This novel feature prevents direct sunlight from negating the capturing of useful sky images by saturating or damaging the camera's detector. Another novel feature is this invention can be used with different models of cameras and is not tied to a particular camera. The construction of the environmentally protected enclosure is dependant on the type of camera used to image the cloud cover. Once captured, the images are automatically transferred to a separate computer for contemporaneous viewing and/or analysis at a future time.

A second object of this invention is to mount a web-enabled camera within an environmentally protected enclosure and placing the protected enclosure in communication with an off-the-shelf solar tracker. The captured image will be transmitted to a computer or other appropriate display unit for contemporaneous viewing and/or analysis at a future time.

A third object of this invention is to mount an off-the-shelf digital camera capable of capturing color images within an environmentally protected enclosure and to place the protected enclosure in communication with an off-the-shelf solar tracker to generate a digital pixel image of daylight cloud cover. The captured image would be transmitted to a computer or other appropriate display unit for viewing and/or analysis contemporaneously or at a future time.

A fourth object of this invention is to mount a wide-angle infrared camera within an environmentally protected enclosure and placing the protected enclosure in communication with an off-the-shelf solar tracker for imaging nighttime cloud cover. It is contemplated that the infrared camera comprises an infrared lens capable of providing a 360 azimuthal and at least a 180-degree horizon-to-horizon view. The captured image will be transmitted to a computer or other appropriate display unit for contemporaneous viewing and/or analysis at a future time.

A still further object of this invention is to house a camera capable of outputting a color analog and/or digital signal within an environmentally protected enclosure and placing the protected enclosure in communication with an off-the-shelf solar tracker to capture images of cloud cover. This invention also contemplates transmitting the analog signal to a computer or other appropriate display unit for viewing and/or analysis contemporaneously or at a future time.

Within the contemplation of this invention the camera assigned for daylight cloud cover observation (color cameras, digital cameras, web-enabled cameras and other off-the-self cameras capable of capturing a useful image based on light visibility) and the infrared camera for nighttime cloud cover imaging may be used advantageously in combination for cloud cover at all times (i.e. during both daylight and nighttime conditions). The images of the two cameras may be toggled back and forth. It is also contemplated that the images of the two cameras may be combined to provide a general uniform pictorial view of the cloud cover, or analyzed in conjunction with one another to infer cloud and sky properties that each alone cannot address.

### BRIEF DESCRIPTION OF THE DRAWINGS

The following detailed description of the embodiments of the invention will be more readily understood when taken in conjunction with the following drawing, wherein:

The FIGURE: An illustration of the apparatus of the present invention.

### DETAILED DESCRIPTION OF THE PREFERRED EMBODIMENTS

For the purposes of promoting an understanding of the principles of the invention, reference will now be made to the embodiments illustrated in the drawing and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the art that some of the features which are not relevant to the invention may not be shown for the sake of clarity.

As used herein the following terms shall have the assigned meanings: The term communication shall mean attached, bolted, coupled, fixed, riveted, locked, mounted, secured, set, or welded.

The term solar tracker means an instrument typically having a computer/controller that uses an accurate clock for local time, local position (latitude, longitude, and altitude) to determine the location of the sun. Motors within the solar tracker then keep the tracker pointed toward the sun. Examples of solar trackers are: 1) Kipp & Zonen Model 2AP Two Axis Positioner, 2) Brussag INTRA, and 3) Eppley Laboratory's Model ST-1.

The term cron means a Unix program for scheduling tasks.

The term web-enabled camera means any camera capable of operating in a mode so that camera's images are frequently delivered to a processing computer.

As used herein, the term digital camera means any camera that breaks up a picture into a fixed number of pixels and converts the light intensity (or the intensities of each of the primary colors) in each pixel to one of a finite set of numbers.

Referring now to the FIGURE, there is shown one example of the present invention. As therein depicted, the broad aspects of the present invention 10 includes at least one interchangeable camera 12 capable of capturing a color image and having a minimum of one fish-eye lens 14 capable of providing a 360 degree azimuthal view, and 180 degree or more horizon-to-horizon view. The camera 12 is housed in an environmentally protected enclosure 16 so as to permit the camera 12 to capture a 360-degree azimuthal view, and 180-degree or more horizon-to-horizon view of the skyline. The robustness of the environmental enclosure 16 is determined by the specific camera used. Web-enabled cameras will generally require more protection than a digital camera because they are generally designed for indoor use. The environmentally protected enclosure 16 is in communication with an off-the shelf solar tracker 18. A preferred tracker is the Kipp & Zonen Model 2AP Two-Axis Positioner, wherein the image of the sun 26 is blocked by at least one solar tracker obscuration ball 20. The camera 12 captures images of clouds 28 at a preset interval of time. Typically the cloud images are captured at a rate of one image per minute but one may reduce this or increase this rate depending on user data needs. The color image is transmitted to an appropriate display unit (not shown) by an operatively connected transfer unit 22. The entire apparatus is powered by an appropriate power source 24. The apparatus is powered continuously so that it can actively track the sun 26. Power can be obtained from either commercially available power or generators if commercial power is unavailable. The preferred method of power is 230/120 volts AC 50/60 Hz. As the earth rotates, the obscuration ball 20 keeps the camera 12 obscured from the sun 26 thus effectively casting a shadow 30 over the lens of the camera allowing the capture of the cloud images without danger of damaging or saturating the camera detector array (not shown). Through the use of conventional optical cameras, the present invention 10 provides a continuous record of cloud images from sunrise to sunset, while also allowing for nighttime imaging through the use of an infrared camera or visible camera of increased sensitivity or capable of long exposure times.

In the most basic embodiment of this invention, the All Sky Imager 10 utilizes a web-enabled camera. In this embodiment, the web-enabled camera is preferably an Axis 2120 operating in a mode so that images are frequently delivered to a processing computer, for example at a rate of one image per minute. An operatively connected transfer unit 22 transfers the captured images by programming the web-enabled camera to automatically transfer the image. A second way of transferring the captured images is to use another computer to grab the images via file transfer protocol or similar protocol. The Axis 2120 utilizes a Unix operating system that allows entries into its cron program that sets up a schedule for transferring the captured images to a specific computer that is linked to the internet or intranet.

In another basic embodiment of this invention, the present invention 10 utilizes a digital camera capable of capturing a color image of the cloud cover. In this embodiment the digital camera is preferably a high resolution digital camera, such as for example the Kodak Megaplus Model ES 1.0 Progressive Scan, 1024×1024 pixel CCD or other similarly high resolution cameras. An operatively connected transfer unit 22 transfers the captured cloud image via a standard interface 22 (e.g. RS-232, USB, or Firewire) to a computer.

In still another basic embodiment of the present invention, the present invention 10 utilizes a camera capable of capturing a color image wherein the image is outputted via an analog video signal by an operatively connected transfer unit 22 to a computer with an appropriate interface board. The signal may be transported by either a copper wire, fiber optic cable, or various wireless wavelength transport (e.g. radio frequency, microwave or infrared). The signal will then be input into a frame grabber board mounted on a computer (not shown).

In still another further basic embodiment of the present invention, the present invention 10 utilizes a camera comprising an infrared lens capable of providing a 360 azimuthal view and at least a 180-degree horizon-to-horizon view. An operatively connected transport unit 22 will transport the received infrared image to an appropriate display unit (not shown).

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth and as follows in scope of the appended claim.

The invention claimed is:

1. An apparatus comprising,
a. at least one interchangeable camera capable of capturing a color image comprising at least one lens capable of providing a 360 azimuthal view and at least a 180-degree horizon-to-horizon view;
b. an environmentally protected enclosure comprising said at least one interchangeable camera;
c. a solar tracker;
d. at least one obscuration ball affixed to said solar tracker such that said ball is continuously positioned to cast a shadow on said lens;
e. said enclosure in communication with said solar tracker;
f. an operatively connected transfer unit to transfer said image from said at least one interchangeable camera to at least one appropriate display unit; and
g. a power source.

2. The apparatus in claim 1 wherein the camera is a web-enabled camera capable of delivering a captured image to an appropriate display unit that is linked to the internet.

3. The apparatus in claim 1 wherein the camera is a digital camera capable of capturing a color image.

4. The apparatus in claim 1 wherein the camera comprises an infrared camera.

5. The apparatus in claim 1 wherein the appropriate display unit is a computer.

6. The apparatus in claim 1 wherein said image is transferred via an analog video signal to a computer with an appropriate interface board.
